(19) United States
(12) Patent Application Publication
(10) Pub. No.: US 2026/0292055 A1
(43) Pub. Date: Sep. 24, 2026

(54) Method and System for Switching between Multiple Communication Connections for Audio Streaming

(71) Applicant: Apple Inc., Cupertino, CA (US)

(72) Inventors: Natalia A. Fornshell, Bozeman, MT (US); Suraj Sumangala, Dublin, CA (US); Aarti Kumar, Los Altos, CA (US); Andrew J. Lucas, San Francisco, CA (US); Baek S. Chang, San Francisco, CA (US); Thibaut X. Mauron, Santa Clara, CA (US); Hilary K. Mogul, San Diego, CA (US)

(21) Appl. No.: 19/537,151

(22) Filed: Feb. 11, 2026

Related U.S. Application Data
(60) Provisional application No. 63/775,214, filed on Mar. 20, 2025.

(51) Int. Cl. H04M 1/72412

(52) U.S. Cl. CPC H04M 1/72412; H04R 2420/07

(57) ABSTRACT

A method that includes establishing a first wireless connection between a first electronic device and the headset that is worn on a head of a user; establishing a second wireless connection between a second electronic device and the headset; receiving, via a wired connection with the first electronic device, a first audio signal for audio playback through at least one speaker of the headset; receiving, via the second wireless connection, a second audio signal from the second electronic device; and responsive to the receiving of the second audio signal and without user intervention, using the second audio signal for audio playback through the at least one speaker of the headset in lieu of the first audio signal.

### RELATED APPLICATIONS

This application claims the benefit of priority of U.S. Provisional Application No. 63/775,214, filed Mar. 20, 2025, which is herein incorporated by reference.

### FIELD

An aspect of the disclosure relates to a method and system for switching between multiple communication connections between multiple electronic devices for audio playback at an output device. Other aspects are also described.

### BACKGROUND

Headphones are an audio device that includes a pair of speakers, each of which is placed on top of a user's ear when the headphones are worn on or around the user's head. Similar to headphones, earphones (or in-ear headphones) are two separate audio devices, each having a speaker that is inserted into the user's ear. Both headphones and earphones are normally wired to a separate playback device, such as an MP3 player, that drives each of the speakers of the devices with an audio signal in order to produce sound (e.g., music). In other cases, the audio devices may be wireless such that they wirelessly receive audio data from a companion device for output through one or more speakers. Headphones and earphones provide a convenient method by which the user can individually listen to audio content without having to broadcast the audio content to others who are nearby.

### SUMMARY

According to one aspect of the disclosure, a method performed by a headset that includes: establishing a first wireless connection between a first electronic device and the headset that is worn on a head of a user; establishing a second wireless connection between a second electronic device and the headset; receiving, via a wired connection with the first electronic device, a first audio signal for audio playback through at least one speaker of the headset; receiving, via the second wireless connection, a second audio signal from the second electronic device; and responsive to receiving the second audio signal and without user intervention, using the second audio signal for audio playback through the at least one speaker of the headset in lieu of the first audio signal.

In one aspect, the method further includes: transmitting, via the first wireless connection and to the first electronic device, control data indicating that the audio playback of the first audio signal is to be paused or stopped; and responsive to the transmitting of the control data, ceasing to receive the first audio signal through the wired connection. In another aspect, the method further includes receiving, via the second wireless connection and from the second electronic device, an indication produced by the second electronic device responsive to the second electronic device receiving user input at the second electronic device to cause the headset to playback the second audio signal. In some aspects, the second wireless connection is a bi-directional wireless connection, the method further includes: capturing, using a microphone of the headset, a microphone signal that includes speech data of the user of the headset; and transmitting, via the bi-directional wireless connection, the microphone signal to the second electronic device such that the user of the headset may perform a communication session through the second electronic device.

In one aspect, the first wireless connection, the second wireless connection, and the wired connection are contemporaneously active to allow the headset to exchange data with the first electronic device and the second electronic device. In another aspect, the method further includes: in response to the wired connection between the headset and the first electronic device being disconnected, receiving, via the first wireless connection, the first audio signal from the first electronic device; determining which of the first audio signal or the second audio signal is to be used for the audio playback based on the first wireless connection and the second wireless connection; and in response to the determining, using either the first audio signal or the second audio signal to drive the at least one speaker. In some aspects, the second audio signal and the first audio signal comprise the same audio content, where the second audio signal is received via the second wireless connection responsive to the wired connection between the first electronic device has been disconnected.

According to another aspect of the disclosure, a first electronic device that includes: at least one processor; and memory having instructions which when executed by the at least one processor causes the first electronic device to: establish a first wireless connection with a headset that is worn on a head of a user, while the headset is communicatively coupled with a second electronic device via a wired connection and a second wireless connection, where the headset is configured to receive a first audio signal via the wired connection for audio playback through at least one speaker; determine that the headset is to play back a second audio signal; and transmit, via the first wireless connection, the second audio signal to the headset, where the headset is configured to play back the second audio signal through the at least one speaker instead of the first audio signal, while maintaining the first wireless connection with the second electronic device.

In one aspect, the instructions to determine include instructions to receive user input to initiate playback of audio content, where the second audio signal that comprises the audio content is transmitted responsive to a reception of the user input. In another aspect, the first wireless connection includes a bi-directional wireless connection, where the user input is to initiate an audio communication session between the headset and a remote electronic device, where the second audio signal comprises a downlink audio signal of the audio communication session, where the memory includes further instructions to receive, via the bi-directional wireless connection a microphone signal captured by a microphone of the headset for transmission to the remote electronic device. In some aspects, the first audio signal includes user-desired audio content that is paused during the audio communication session.

In one aspect, the instructions to determine that the headset is to play back the second audio signal includes instructions to receive, via the first wireless connection, a control signal to cause the first electronic device to provide the second audio signal, where the control signal is received responsive to the wired connection between the headset and the first electronic device being disconnected. In another aspect, the first audio signal and the second audio signal include the same audio content. In some aspects, the first electronic device includes a portable electronic device and the second electronic device comprises a stationary electronic device.

According to another aspect of the disclosure, a non-transitory machine-readable medium having instructions which when executed by at least one processor of an electronic device causes the electronic device to: receive an audio signal, where the electronic device is communicatively coupled with 1) a first source device via a first wireless connection and a wired connection through which the audio signal is received, and 2) a second source device via a second wireless connection; use the audio signal to drive at least one speaker of the electronic device; receive, via the second wireless connection from the second source device, a subsequent audio signal; and responsive to the receiving of the subsequent audio signal and without user intervention, use the subsequent audio signal to drive the at least one speaker instead of the audio signal.

In one aspect, the non-transitory machine-readable medium further includes instructions to receive, via the second wireless connection and from the second source device, an indication produced by the second source device responsive to the second source device receiving user input at the second source device to cause the electronic device to use the subsequent audio signal to drive the at least one speaker instead of using the audio signal. In another aspect, the second wireless connection is a bi-directional wireless connection, where the non-transitory machine-readable medium includes further instructions to: capture, using a microphone, a microphone signal that includes speech data of a user of the electronic device; and cause the electronic device to transmit, via the bi-directional wireless connection, the microphone signal to the second source device such that the user of the electronic device may perform a communication session through the second source device.

In one aspect, in response to the wired connection between the electronic device and the first source device being disconnected, receive, via the first wireless connection, the audio signal from the first source device; determine which of the audio signal or the subsequent audio signal is to be used for audio playback based on the first wireless connection and the second wireless connection; and in response, use either the audio signal or the subsequent audio signal to drive the at least one speaker. In another aspect, the subsequent audio signal and the audio signal include the same audio content, where the subsequent audio signal is received via the second wireless connection responsive to the wired connection with the first source device having been disconnected. In some aspects, the first source device includes a stationary electronic device and the second source device includes a portable electronic device.

The above summary does not include an exhaustive list of all aspects of the disclosure. It is contemplated that the disclosure includes all systems and methods that can be practiced from all suitable combinations of the various aspects summarized above, as well as those disclosed in the Detailed Description below and particularly pointed out in the claims. Such combinations may have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect of this disclosure are not necessarily to the same aspect, and they mean at least one. Also, in the interest of conciseness and reducing the total number of figures, a given figure may be used to illustrate the features of more than one aspect, and not all elements in the figure may be required for a given aspect.

FIG. 1 shows a system for establishing a unified communication interface between electronic devices for audio streaming according to one aspect.

FIG. 2 shows a block diagram of the system that includes a source device and an output device according to one aspect.

FIG. 3 is a signal diagram of one aspect to establish a unified communication interface that includes a wired connection and a wireless connection between two devices, and to switch between the two connections.

FIG. 4 is a flowchart of one aspect of a process to perform signal processing operations based on control data received from an output device over a wireless connection of a unified communication interface.

FIG. 5 is a flowchart of one aspect of a process to switch between the wired connection and the wireless connection for establishing and conducting an audio communication session.

FIG. 6 is a signal diagram of one aspect to switch between connections between multiple electronic devices for audio playback at the output device.

FIG. 7 illustrates an example of system hardware.

### DETAILED DESCRIPTION

Several aspects of the disclosure with reference to the appended drawings are now explained. Whenever the shapes, relative positions and other aspects of the parts described in a given aspect are not explicitly defined, the scope of the disclosure here is not limited only to the parts shown, which are meant merely for the purpose of illustration. Also, while numerous details are set forth, it is understood that some aspects may be practiced without these details. In other instances, well-known circuits, structures, and techniques have not been shown in detail so as not to obscure the understanding of this description. Furthermore, unless the meaning is clearly to the contrary, all ranges set forth herein are deemed to be inclusive of each range's endpoints.

As referenced herein, “audio content” or “audio data” may be (and include) any type of (e.g., user-desired) audio, such as a musical composition, a podcast, audio of an extended reality (XR) environment (e.g., virtual reality (VR) environment, mixed reality (MR) environment, and/or augmented reality (AR) environment), a soundtrack of a motion picture, etc. In one aspect, the audio data may be a part of a piece of audio content, which may be an audio program or audio file that includes one or more audio signals that includes at least a portion of the audio content. In some aspects, the audio program may be any type of audio content format. In one aspect, an audio program may include audio data for spatial rendering as one or more data files in one or various three-dimensional (3D) audio formats, such as having one or more audio channels. For instance, an audio program may include a mono audio channel or may be a multi-audio channel format (e.g., two stereo channels, six surround source channels (in 5.1 surround format), etc.). In another aspect, the audio program may include one or more audio objects, each having at least one audio signal, and positional data (for spatially rendering the object's audio signals) in 3D sound. In another aspect, the audio program may be represented in a spherical audio format, such as higher order ambisonics (HOA) audio format.

In another aspect, audio data may include audio content of a software application that is being executed on one or more electronic devices. For example, when the software program is a media application that may be configured to provide media content, such as a motion picture, the audio data may be the soundtrack of that motion picture. As another example, when the software application is a telephony application, the audio data may be a downlink signal received (e.g., via a telecommunications network) from a remote device with which a local device (that may be executing the telephony application) is conducting a call. As another example, the audio data may include speech of a virtual personal assistant (VPA) provided by a VPA software program.

Wireless headphones enable a user to wirelessly stream audio, such as music, from a companion (audio) device, such as a smartphone, which may retrieve the audio from a remote audio content server. Some wireless headphones may be able to connect to a device through a wired (or cable) connection. For example, the headphones and the companion device may include connections (or sockets) that are sized to receive connectors or plugs, such as 3.5 millimeter (mm) headphone jacks (e.g., auxiliary (AUX) connectors), attached at either end of a cable. With both devices connected via a cable, the companion device may be able to stream audio through the cable for playback at the headphones. Conventional audio devices, however, are unable to simultaneously and/or contemporaneously establish both a wireless connection and a wired connection between a companion electronic device and wireless headphones. For instance, when conventional devices are connected through a cable, any wireless connection between the devices is terminated (broken down) so that both devices are only communicatively coupled via the cable. This breakdown of the wireless connection ensures that the companion device does not stream different or mismatching audio streams over the different connections to the headset for playback.

Only having one connection between the headphones and the companion device has drawbacks. When both devices are wirelessly connected, other data (e.g., playback data) may be exchanged between the devices. For example, the headphones may wirelessly transmit a control signal for the companion device to pause audio playback. The headphones may also be able to wirelessly transmit other data, such as speech data captured by a microphone of the headphones. Such communication, however, may not be possible while connected through a wired connection that may only allow for audio streaming, such as an AUX port that only allows external audio output (e.g., uni-directional output) through an output (or playback) device. Although wireless headphones may be able to exchange audio data and other data wirelessly, such wireless communication may adversely affect the quality of the audio playback. For example, a wired connection may allow for better quality audio to be streamed to the headphones as opposed to streaming audio through a wireless connection. In particular, a wired connection may allow for lossless audio to be streamed to the headphones, while audio streamed wirelessly (e.g., streamed through BLUETOOTH protocol) may require significant compression due to a limited bandwidth. Therefore, there is a need for a unified communication interface between electronic devices to allow for high quality audio playback via a wired connection, while also providing a wireless transport for other data communication.

The present disclosure provides a system that is capable of establishing a unified (or dual) wired and wireless interface between a source device and an output device, such as a headset. In particular, the system may establish a wireless connection between the output device and the source device. The system may transmit, through a wired connection between both devices, audio data to the output device for audio playback. The system may establish the wireless connection in response to determining that the wired connection is established or may be established before the wired connection is formed (e.g., before either end of a cable is plugged into sockets of both devices). The source device may receive control data from the headset, which may include sensor data such as head tracking data. The source device may modify the audio data according to the head tracking data in order to account for movement of a user's head, and may transmit the modified data to the headset. As a result, the system is capable of providing high quality audio data to the headset through the wired connection, while still communicating to the headset through the wireless connection to receive control data, such as head tracking data, which may be used to modify (or update) the streamed audio.

In addition, the present disclosure provides a seamless method for switching between connections based on changing conditions, without requiring user interference (e.g., automatically). In particular, switching between both types of connections may be cumbersome and burden the user experience. Conventionally, when a wired connection is terminated (e.g., a user unplugs a cable that connects wireless headphones to a companion device that has been streaming audio data to the headphones through the cable), the user may be required to manually wirelessly connect the headphones back the companion device or to another device. For instance, once a plug is removed, a user may be required to enter the device wireless settings of the companion device and manually connect the wireless headphones to the companion device. Once wirelessly connected, the user may be required to manually restart audio playback which may have been paused due to the disconnecting of the plug. The present disclosure, however, solves this problem by providing the unified wireless and wired communication interface that enables devices to seamlessly use and switch between connections without user interference. For example, the present disclosure provides a method in which once the wired connection is disconnected, the system is configured to switch audio streaming from using the wired connection to using a wireless connection. Such operations may be performed in the background (e.g., not requiring user interaction with either device) to switch from streaming the audio through the wired connection to streaming the audio through the wireless connection when the cable is unplugged, thereby improving the user's overall experience.

Moreover, the present disclosure provides a method and system for switching between multiple communication connections for audio streaming. As described herein, the present disclosure may provide the capability of a headset and a source device, such as a desktop computer, for establishing a unified communication interface using a wired connection and a wireless connection for streaming audio and other data. In some cases, however, a user may wish to stream audio data from another electronic device, such as a smart phone, to the headset for audio playback. For example, a user may wish to conduct an audio communication session (e.g., an audio call) through the headset. In a conventional audio system, in order for wireless headphones to stream audio from a different electronic device, a user may be required to break down the wireless connection between the headset and the first device, and wirelessly connect the headset with the new device. For example, the user may manually cause the wireless headset to enter a pairing mode (e.g., through a physical button on the headset), and may cause the headset to pair with the new device through a user-selection in a settings menu of the device. These tasks may be cumbersome and time-consuming for the user.

To solve this problem, the present disclosure provides a system for switching between multiple communication connections with multiple electronic devices for audio streaming. The system establishes a first wireless connection between a first electronic device (e.g., a desktop computer) and a wireless headset that is worn on a head of a user, and establishes a second wireless connection between a second electronic device (e.g., smart phone) and the wireless headset. The system receives, via a wired connection with the first electronic device, a first audio signal for audio playback through at least one speaker of the headset. The system receives, via the second wireless connection, a second audio signal from the second electronic device. In one aspect, this section audio signal may be received in response to user input at the second electronic device for causing the wireless headset to playback user-desired audio content, such as a musical composition or speech of an audio call. Responsive to receiving the second audio signal and without user intervention, the wireless headset may use the second audio signal for audio playback through the speaker of the headset instead of the first audio signal. As a result, the wireless headset, while connected to the first electronic device via a wired connection, may automatically switch to a wireless connection with a different electronic device for audio streaming. This may allow the system to route user-desired audio by switching audio streaming between a wired connection and/or wireless connections with one or more electronic devices.

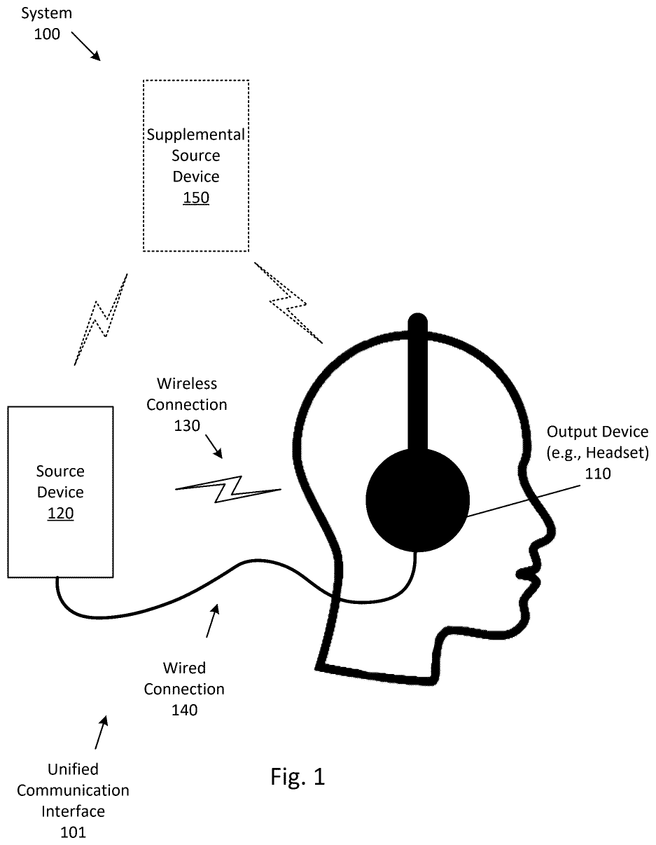

FIG. 1 shows a system 100 for establishing a unified communication interface 101 between electronic devices for audio streaming according to one aspect. The system 100 includes a (audio) source device 120, an output device 110, and an optional supplemental (audio) source device 150. As described herein, the source device may be a stationary electronic device (e.g., a device designed to be used in one location and/or plugged into a main power source) such as a desktop computer, while the supplemental source device 150 may be a portable electronic device (e.g., a device designed for mobility with an internal power source), such as a smart phone. The system may be configured to establish the unified communication interface (or unified interface) 101 that includes a wired connection 140 and a wireless connection 130 between the source device 120 and the output device 110 and/or one or more another wireless connections between the supplemental source device 150 and one or more of the other electronic devices (e.g., output device 110) in the system. In one aspect, the system 100 may establish the wireless and/or wired connections simultaneously and/or contemporaneously with each other such that the devices may exchange data through multiple connections (or transports). For example, the source device 120 may transmit audio data through the wired connection 140, while exchanging data, such as control data, through the wireless connection 130. Both of these connections may be simultaneously established and may exchange (or stream) their respective data contemporaneously. Thus, the output device 110 may be configured to establish multiple wireless connections 130 between the source device and supplemental source device, where the wireless connections may remain active and persistent, while the wired connection 140 is established between the source device and output device. In one aspect, the wireless connections remain active by enabling either of the connected devices to exchange data with the output device, while the source device streams audio data to the output device. In another aspect, the connections may be established serially (e.g., one after the other), and/or may be broken down and established (or re-established) dynamically, while in use. For instance, the wireless connection 130 may be first established, where by audio data may be exchanged between the source device 120 and the output device 110, and then the wired connection 140 may be subsequently established for streaming audio data, for example.

In one aspect, the system 100 may include more or fewer elements, such as not having the supplemental source device 150. In another aspect, the system may include multiple supplemental source devices, each of which may be wirelessly connected or may be capable of being wirelessly connected with the output device 110 and/or the source device 120.

In one aspect, the source device 120 may be any electronic device (e.g., with electronic components, such as one or more processors, memory, etc.) that is capable of streaming audio content, in any format, such as a single (e.g., mono) audio signal, stereo audio signals, or binaural audio signals for playback (e.g., via one or more speakers integrated within the source device and/or via one or more output devices, as described herein). In another aspect, the source device 120 may be any type of electronic device that is capable of having a wired connection and/or a wireless connection with one or more other devices. For example, the source device may be a desktop computer, a laptop computer, a digital media player, etc. In one aspect, the device may be a portable electronic device (e.g., being handheld operable), such as a tablet computer, a smartphone, etc. In another aspect, the source device may be a wearable device (e.g., a device that is designed to be worn on or attached to clothing and/or a body of) a user, such as a smart watch or smart glasses.

In one aspect, the output device 110 may be any (e.g., portable) electronic device that may be configured to establish a wired and/or wireless connection with one or more other electronic devices, and may include at least one speaker and is configured to output (or playback) sound by driving the speaker(s) with audio signal(s). For instance, as illustrated, the output device 110 may be a wireless headset (e.g., over-the-ear headphones) that are designed to be positioned on and over the user's ears and are designed to output sound directed towards the user's ear canal. In which case, the headset may include two ear cups, one for each ear. The headset may be configured to output at least one audio channel of audio content, such as a right audio channel through a speaker of a right ear cup and a left audio channel through a speaker of a left ear cup, thereby allowing for two-channel audio output such as a stereophonic recording (e.g., musical work). In another aspect, the output device may be any electronic device that includes at least one speaker and is arranged to be worn by the user and arranged to output sound by driving the speaker with an audio signal. As another example, the output device may be any type of headset, such as an on-ear or in-ear headphones, such as earphones. In some aspects, the earphone may be a sealing type that has a flexible ear tip that serves to acoustically seal off the entrance of the user's ear canal from an ambient environment by blocking or occluding in the ear canal. In another aspect, the output device 110 may be a wearable electronic device, such as smart glasses or a smart watch.

In some aspects, the output device 110 may be a head-worn device, as illustrated herein. In another aspect, the output device may be any electronic device that is arranged to output sound into an ambient environment. Examples may include a stand-alone speaker, a smart speaker, a home theater system, or an infotainment system that is integrated within a vehicle. In another aspect, the output device as a head-worn device may be arranged to output sound into the ambient environment. For instance, when the output device is a pair of smart glasses, the output device may include “extra-aural” speakers that are arranged to project sound into the ambient environment (e.g., in a direction that is away from at least a portion, such as ears or ear canals, of a wearer), which are in contrast to “internal” speakers of a pair of headphones that are arranged to project sound into (or towards) a user's ear canal when worn.

As described herein, the output device 110 may be a wireless device that may be configured to communicatively couple to the source device 120 via a wireless connection 130 and/or a wired connection 140 in order to exchange data. In one aspect, the wireless connection 130 may be established using any wireless communication protocol, such as BLUETOOTH protocol. During the established wireless connection 130, the devices may exchange (e.g., transmit and receive) data packets (e.g., Internet Protocol (IP) packets) with each other. In another aspect, the wired connection 140 may be established by connecting connectors at opposite ends of a cable to corresponding sockets of the source device and the output device. The cable may be any type of cable with any type of connectors, such as media jacks (e.g., AUX connectors) or Universal Serial Bus (USB) connectors, which plug into sockets of the devices. Once the connectors are plugged into the device's sockets, the source device may be configured to stream one or more audio signals for audio playback at the output device using any wired communication protocol. In one aspect, the audio signals may be in the form of digital audio (e.g., PCM digital audio), or may be in the form of any type of audio format.

In one aspect, any of the wireless connections, such as wireless connection 130, may be an active (or persistent) connection contemporaneously with the wired connection in order to allow data to be exchanged between both devices through both connections. As described herein, this is in contrast to conventional systems, whereby once a wired connection is established, a wireless connection between both electronic devices is broken down (or terminated).

In some aspects, the source device 120 and the output device 110 may be distinct (separate) electronic devices, as shown herein. In another aspect, the source device may be a part of (or integrated with) the output device. For example, at least some of the components of the source device (such as one or more processors, memory, etc.) may be part of the output device, and/or at least some of the components of the output device may be part of the source device. In which case, at least some of the operations performed by the source device (e.g., streaming audio content from a remote server) may be performed by the output device.

As described herein, the supplemental source device 150 may be a portable device, such as a smart phone, a tablet computer, or a laptop. In another aspect, the supplemental source device may be a wearable device, such as a smart watch or smart glasses. In some aspects, the supplemental source device 150 may be any one of the electronic devices, as described herein.

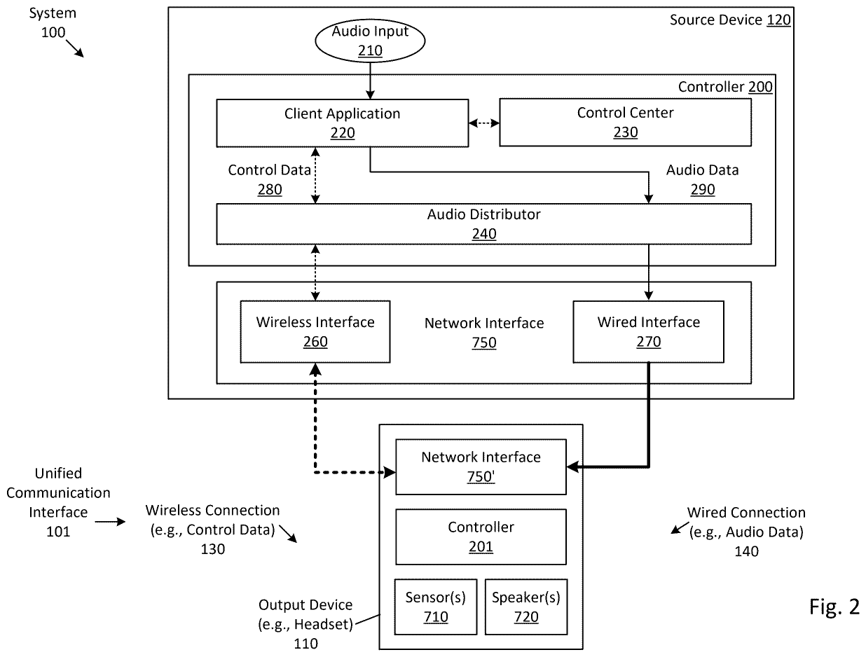

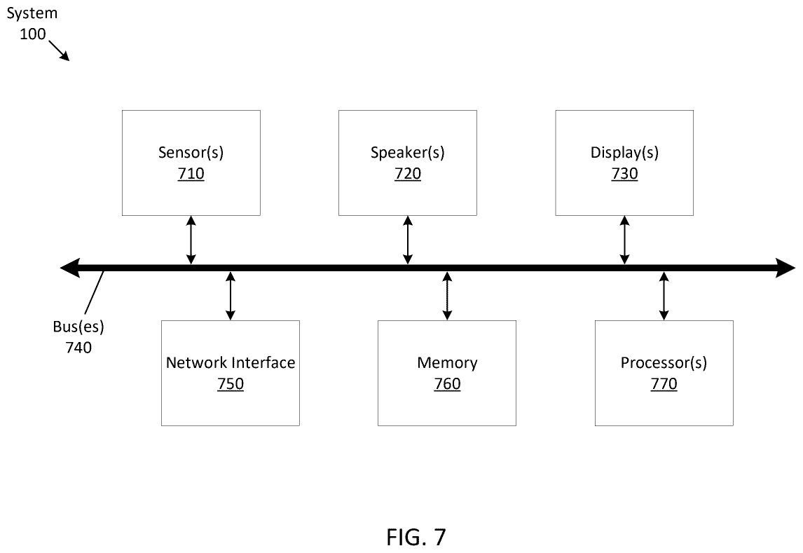

FIG. 2 shows a block diagram of the system 100 that includes the source device 120 and the output device 110 according to one aspect. The source device includes an audio input 210, a controller 200, and a network interface 750. The controller 200 includes a client application 220, a control center 230, and an audio distributor 240. In one aspect, the source device may include other components, such as memory. In one aspect, the output device may include one or more electronic components, such as one or more processors (controllers), a network interface, and memory, which may be used to perform one or more operations as described herein. For instance, the output device 110 includes a network interface 750′, may be configured to perform similar operations as the network interface 750 in order to establish the unified communication interface 101 with one or more other electronic devices, a controller 201, one or more speakers 720 for playing back audio, and/or sensors 710 for detecting (producing) sensor data, which may be based on the environment in which the output device is located, as described in FIG. 7.

The audio input 210 may include a programmed processor that may be configured to run a media player software application and may include a decoder that is configured to produce an input audio signal as digital audio input to the output device. In another aspect, the media application may be a part of the client application 220, which may be configured to retrieve (receive) audio content from the audio input 210. For instance, the client application 220 may execute a media player and may retrieve audio content for streaming to the output device. In one aspect, the audio input 210 may include a decoder that may be capable of decoding an encoded audio signal, which has been encoded using any suitable audio codec, such as, e.g., Advanced Audio Coding (AAC), Moving Picture Experts Group (MPEG) Audio Layer II, MPEG Audio Layer III, or Free Lossless Audio Codec (FLAC). Alternatively, the audio input may include a codec that is converting an analog or optical audio signal, from a line input, for example, into digital form for the controller.

The client application 220 may be any type of software application for playing back and/or streaming audio content through one or more speakers (e.g., of the output device 110). As described herein, the client application 220 may be a media player software application that may provide media audio content associated with the (executing) application. For example, the audio content may be a musical composition, a movie soundtrack, a podcast, etc. In another aspect, the client application 220 may include a telephony software application that may be configured to provide telephony audio content as a downlink audio signal of a call that may be established between the output device and another (e.g., remote) electronic device. As another example, the client application may include a VPA software application that may be configured to provide VPA audio content that may include audible notifications of the VPA, which may be provided responsive to commands or requests of a user of the output device.

In one aspect, the client application 220 may be configured to generate spatial audio data for spatial audio playback (e.g., by the output device 110). For example, the client application 220 may apply spatial filters (e.g., head-related transfer functions (HRTFs) filters) that may be personalized for the user of the system 100 in order to account for the user's anthropometrics. In another aspect, the spatial filters may be generic (or default) filters. As a result, the client application 220 may be configured to produce spatial audio signals, such as binaural audio signals produced based on one or more HRTF filters, which when played back through one or more speakers of the output device 110 produces a three-dimensional (3D) sound (e.g., giving the user wearing the output device 110 the perception that sounds are being emitted from a particular location within an acoustic space.)

The control center 230 may be configured to manage configuration parameters of the system 100. In one aspect, the control center 230 may keep track of the configuration or operational mode of the output device 110. For example, the (e.g., controller 201 of the) output device may be configured to operate in an active noise cancellation (ANC) mode to cause one or more speakers 720 of the output device to produce anti-noise based on one or more microphone signals captured by microphones (e.g., of the output device 110) in order to reduce ambient noise from the environment that may leak into the user's ears while the user wears the output device 110. In another aspect, the (e.g., controller 201 of the) output device may operate in ambient sound enhancement (ASE) mode in which ambient sound captured by one or more microphones of the output device may be played back by the output device to reproduce at least a portion of the sound. Such a function may be referred to as a “pass through” or “transparency” mode in which sounds of the environment are reproduced by a speaker of the output device (as one or more ASE signals) in a “transparent” manner, e.g., as if the output device were not being worn by the user (when the output device is a headset). Returning to the control center 230, this application may be configured to keep track of the operational mode and provide a user of the source device 120 an indication of the mode in which the controller 201 of the output device is operating. For example, the control center 230 may display the configuration of the output device through a graphical user interface (GUI), which may be displayed on a display of the source device 120.

The network interface 750 includes a wired interface 270 and a wireless interface 260. The wired interface may be configured to establish a wired connection 140 with one or more electronic devices. In particular, the wired interface may include a socket for receiving a plug (or a connector) of a cable at one end, which may have a plug at an opposite end for connecting to another device, such as the output device. In one aspect, the wired interface may be arranged to establish the wired connection using any type of cable (with any type of connector) that is designed to carry (exchange) data, such as a Universal Serial Bus type-C (USB-C) cable or an Ethernet cable. In one aspect, the wired connection may be any type of connection that may allow an electronic device to transmit data to another device, such as an AUX connection or a USB-C connection. In one aspect, the wired interface may be configured to use any type of wired communication protocol for encoding and transmitting data, such as audio data, through the wired connection and to one or more electronic devices, such as the output device 110. The wireless interface 260 may be configured to establish any type of wireless connection 130 between the source device and one or more wireless electronic devices. For instance, the wireless connection may be a wireless local area network (WLAN) connection through which the output device may connect with another device through the network. In one aspect, the wireless interface may use any type of wireless communication protocol, such as BLUETOOTH, for compressing and transmitting data over the wireless connection.

In one aspect, the network interface 750′ of the output device 110 may include similar (or the same) interfaces as interface 750 in order to establish the wired connection 140 and the wireless connection 130 with the source device(s), as described herein.

In one aspect, the system 100 may preferrable transmit data, such as audio data, through the wired connection 140 as opposed to the wireless connection 130. For example, the wired connection 140 may provide for a greater bandwidth (data throughput) than the wireless connection, such as a BLUETOOTH connection. As a result, the wired connection may have a greater bit (or data) rate than the wireless connection. For example, a wired connection such as USB-C may support data transfer rates up to 40 Gbps, while a wireless connection, such as BLUETOOTH may only support a maximum bit rate of approximately 2 Mbps. In addition, the wired connection may have a lower latency than a latency of the wireless connection. Thus, the wired connection may have a first latency for data transmission, while the wireless connection has a second latency that is higher than the first latency. High latency for audio streaming is not desirable, especially with certain sounds such as system or notification sounds. This higher latency for the wireless connection may be due to additional processing and wireless transmission of data packets, which would not be required for a wired transmission. Moreover, since the wireless connection has a limited bandwidth, data transmission requires a considerable amount of compression, which is in contrast to wired connections. In particular, the wired connection may be a lossless connection requiring little data compression, such as using a high-quality compression codec (e.g., Free Lossless Audio Codec), or no compression (delivering uncompressed audio data). As a result, the wired connection may enable the system to stream the original (uncompressed) audio data for audio playback at the output device. In contrast, since the wireless connection has limited bandwidth (or more limited bandwidth than the wired connection), the wireless connection may require lossy audio compression codecs, such as Subband Coding (SBC) or Advanced Audio Distribution Profile (A2DP) compression methods for BLUETOOTH connections. Although compression allows for wireless transmission of the audio data, some original data is lost due to the compression. As a result, the quality of audio data transmitted through the wired connection may be better than the quality transmitted through the wireless connection.

Returning to the controller 200, the audio distributor 240 may be configured to manage what transport (wired and/or wireless) is used to transmit audio data and to exchange control data between the source device 120 and the output device 110. As described herein, the audio distributor 240 may be configured to cause the source device 120 to transmit audio data through the wired connection 140 (when established) to the output device 110, and transmit other data, such as control data, through the wireless connection 130 to the output device. In one aspect, while the wired connection may be maintained between both devices, the wireless connection may remain active between the devices. In some cases, however, the data transports may switch. In particular, the audio distributor 240 may monitor whether a wired connection is established between the output device and the source device, and upon determining that such a connection is established may transmit audio data (e.g., from the client application 220) through the wired connection to the output device. If, however, the wired connection is not established or is broken down, the audio distributor 240 may be configured to transmit the audio data through the wireless connection 130 (or establish another wireless connection for wireless transport of the audio data). As a result, the audio distributor 240 may determine which mode of transport is most optimal for audio data streaming, without requiring any user input or input from the client application. For example, the audio distributor 240 may determine data transport through the wired connection is more optimal than through the wireless connection, due to reduced latency, and may be configured to cause audio data to be transmitted through the wired connection 140. If, however, the wired connection 140 is broken (abruptly), the audio distributor may then determine the wireless connection to be optimal and continue audio transmission wirelessly in order to prevent disruption to the user experience. In other words, the audio distributor may operate in the background to provide a seamless transition between transports to optimize user experience. As a result, the client application needs only to indicate that (or send) audio data is to be played back, while the audio distributor determines how such audio data is transmitted to the output device for playback. In one aspect, the audio distributor may operate in the Hardware Abstraction Layer (HAL) of the software stack, which interfaces between the client application 220 and the network interface 750 (that may include network hardware). In one aspect, the unified interface combines features of both wireless and wired technologies in the audio driver, which may be operating in the HAL, and switches between the two transports based on various conditions, as described herein.

As described herein, the audio distributor 240 may be configured to provide the audio data 290 from the client application 220 to the output device 110 through the wired connection 140. In addition, the audio distributor 240 may receive control data 280 from the output device 110 through the wireless connection. In one aspect, the audio distributor may use the control data 280 to determine whether data transports need to be switched or remain the same. For instance, the audio distributor may be configured to cause audio data to be transmitted through the wired connection, while established. Once broken, which may be due to a user disconnecting the physical cable, the audio distributor may be configured to switch audio data transmission through the wireless connection. As another example, the audio distributor 240 may determine whether the user has removed the output device 110 from the user's head, thereby indicating that any sound playback needs to be paused. If so, the audio distributor 240 may pause the audio streaming. Other control data 280 may be passed to the client application 220, which may use the data to process the audio data. For example, the client application may determine that the control data 280 includes information such as head tracking data and/or other playback data, which the application may use to modify the audio data. In which case, the client application may spatially render audio content based on movements of a user indicated by the head tracking data, and continue to provide the spatially rendered audio to the output device.

In one aspect, the client application 220 may pass through the control data 280 to the control center 230 to update configuration parameters associated with the output device 110. For example, the control data 280 may indicate an operational mode of the output device. The client application may indicate the mode to the control center 230, which may then update a corresponding parameter. In one aspect, the control center may be configured to display current configuration parameters of the system within a GUI on a display of the source device. For instance, the control center may provide an indication to the user of the system that the controller 201 of the output device is operating in ANC mode. In one aspect, the control center 230 may change configuration parameters through user input (e.g., received through the source device). Continuing with the previous example, if user input is received (e.g., a user selection of a user interface (UI) item displayed on a touch-sensitive display screen of the source device 120) to change the operational mode from ANC mode to ASE mode, the control center 230 may cause the source device to transmit a control signal, via the wireless connection 130 to the output device to change its existing mode. In one aspect, the control center 230 may be configured to instruct the client application 220 to transmit the control signal.

In one aspect, the present disclosure allows for existing software architectures to exchange data wirelessly and provide audio data through a wired connection, without having to adjust those existing architectures. For example, some wireless headphones wirelessly transmit information, such as volume controls, to a companion device that is also wirelessly transmitting audio data for playback at the wireless headphones. The present disclosure allows these wireless headphones to continue to transmit (and exchange) information wirelessly, maintaining their software (e.g., wireless communication) stack, while also playing back higher quality audio data that is received via a wired connection.

As described herein, the wireless connection 130 and the wired connection 140 may remain active simultaneously. The source device 120 may transmit audio data through the wired connection. While the wired connection is established, the source device and the output device may exchange data, such as control data through the wireless connection. In one aspect, this control data may be used to configure which communication transports are used, modify audio data, and adjust configuration parameters associated with the output device (and/or the source device). More about the control data is described herein.

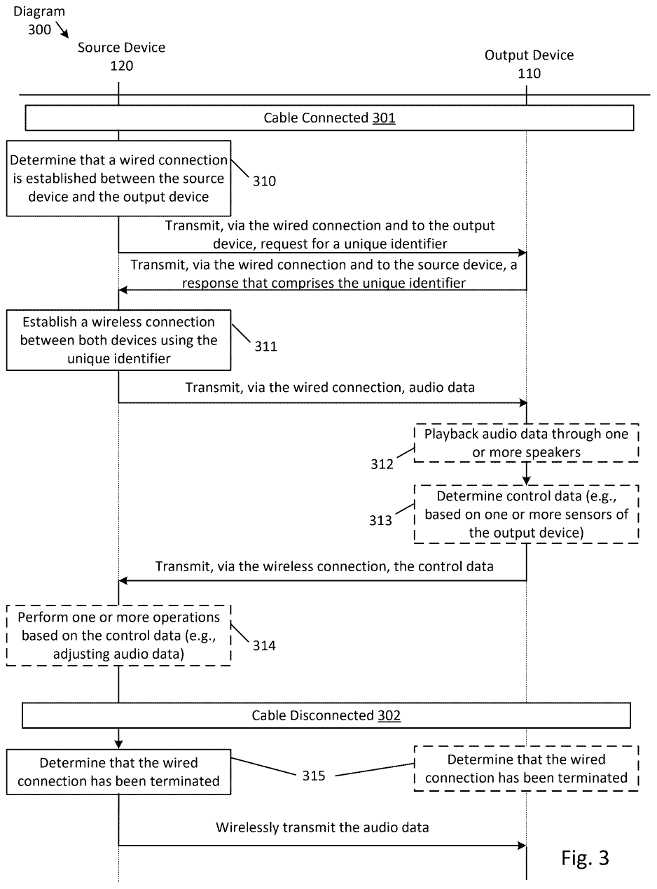

FIGS. 3-6 include operations that may be performed by the system 100 to establish a unified wireless and wired interface between multiple devices and operations performed while the devices are connected to one another. For instance, at least some of the operations may be performed by hardware of one or more devices, such as the controller 200 of the source device 120, the controller 201 of the output device 110, and/or may be performed by software being executed on those devices. In one aspect, at least some of the operations described herein may be performed by the source device and/or the output device of the system 100. Moreover, although the operations are illustrated as being performed by a specific electronic device, at least some of these operations may be performed by different devices that may be communicatively coupled.

FIG. 3 is a signal diagram 300 of one aspect that includes operations performed by the system 100 to establish a unified communication interface that includes the wired connection 140 and the wireless connection 130 between two electronic devices, and to switch between the two connections. As shown, the operations of the diagram 300 may be performed by (e.g., controller 200 of) the source device 120 and the (e.g., controller 201 of the) output device 110. The diagram 300 begins with a cable being connected between the source device 120 and the output device (at block 301). For instance, a first connector of the cable (e.g., USB-C cable) may be connected to a first socket of the (e.g., wired interface 270 of the) source device and a second connector of the cable may be connected to a second socket of the output device 110. In one aspect, the cable may be manually connected by a user of both devices.

The controller 200 of the source device 120 determines that a wired connection is established between the source device and the output device (at bock 310). For instance, upon the establishment of the wired connection, the source device 120 may transmit a message (e.g., ping) to the output device 110 through the wired connection 140, and the output device may transmit a response based on the message, which may inform the controller 200 of the source device that a wired connection is established. In another aspect, the source device 120 may transmit the message to the output device indicating that audio data is to be sent through the wired connection 140, where audio data is transmitted to the output device responsive to the source device receiving an acknowledgment from the output device based on the message. In another aspect, the wired connection 140 may be determined to be established based on the source device receiving a message from the output device over the wired connection. Thus, as the output device is active (e.g., powered on and being worn on the head of the user), a response may be transmitted to the source device indicating that the wired connection is established and/or that audio data may be transmitted (e.g., the output device 110 is ready) for audio playback.

In one aspect, upon establishing the wired connection, the controller 200 of the source device 120 may request information (or parameters) associated with the output device. In which case, the controller 200 may cause the source device to transmit, via the wired connection 140 and to the output device, a request for a unique identifier associated with the output device. In one aspect, the unique identifier may include a wireless address associated with the output device. In another aspect, the unique identifier may be a model and/or serial number of the output device. The controller 201 may cause the output device to transmit, via the wired connection and to the source device, a response that includes the unique identifier. In one aspect, upon receipt of the unique identifier, the controller 200 may be configured to perform a table lookup into a data structure that associates features of the output device, such as wireless address, with unique identifiers to select a corresponding address. The controller 200 may be configured to cause the source device to establish a wireless connection 130 between both devices using the unique identifier (at block 311). In another aspect, both devices may exchange wireless addresses (or unique identifiers). For instance, in response to determining that the wired connection is established (e.g., in response to receiving a message from the output device), both devices may exchange wireless addresses associated with each respective device, whereby the devices may use the others wireless address for establishing and ensuring that the wireless connection is established with the appropriate device. In one aspect, the wireless connection between both devices may be established responsive to a reception of the unique identifier by the source device.

In one aspect, this wireless connection 130 may be established after the wired connection 140 is established, as described herein. In another aspect, the output device 110 may be paired (or registered) with the source device 120, but a wireless connection may not be established. The controller 200 of the source device may then use the unique identifier to establish a communication channel. This may allow the source device to differentiate the output device from other wireless devices that may be already registered with (or wireless connected to) the source device. In another aspect, the output device may already be wirelessly connected to the source device before the wired connection is established. In which case, the source device may use the unique identifier to enable future communication through the existing wireless connection, thereby ensuring that such communication does not occur with other wireless devices with which the source device is connected. The source device 120 transmits, via the wired connection, audio data to the output device. As described herein, this audio data may include one or more audio signals that include audio content such as user-desired audio content (e.g., a musical composition) or may include other content, such as speech of an audio call, for playback by at least one speaker of the output device.

The controller 201 of the output device may be configured to playback the audio data through one or more speakers (at block 312). In particular, the controller 201 of the output device may be configured to drive speakers using one or more audio signals received through the wired connection to reproduce audio content of the signals. The controller 201 of the output device may determine control data, which may be based on one or more sensors 710 of the output device (at block 313). In one aspect, the control data may include sensor data produced by at least one sensor of the output device. For instance, the output device may include an IMU that is designed to determine movements (e.g., position and/or orientation) of a user's head while wearing the output device, which in this case may be a headset. The controller 201 may produce head tracking data based on (or that includes) IMU data. In which case, the control data may include head tracking data that indicates a position (or a movement) of the user's head (e.g., with respect to a reference point). In one aspect, the head tracking data may indicate the one or more angles, such as an azimuth and elevation, of the (e.g., user's head that is wearing the) output device. In another aspect, the control data may indicate whether the controller 201 of the output device is operating in an operational mode, such as an ANC mode. The control data may include other data, such as microphone data and/or proximity sensor data from a proximity sensor. The output device may transmit the control data associated with the output device to the source device via the wireless connection.

The controller 200 of source device 120 may be configured to perform one or more operations based on the control data, such as adjusting the audio data (at block 314). For example, when the control data includes head tracking data, the controller 200 may modify the audio data according to the head tracking data, such that placement of one or more sound sources with respect to a listener position are modified. Thus, the controller 200 may produce binaural audio signals by performing spatial audio rendering operations upon the audio data to account for (according to) the head tracking data in order to account for movement of the user's head. As described herein, the controller 200 may be configured to cause the source device to transmit the adjusted audio data (e.g., based on the received control data) back to the output device for audio playback. Thus, the source device may transmit the binaural audio signals to the output device through the wired connection. More about the operations performed based on control data is described herein.

In one aspect, the controller 200 of the source device 120 may not perform some operations based on configuration parameters associated with the output device 110. For instance, the configuration parameters may indicate whether head tracking is to be performed during audio playback, whereby the position of sound sources may be modified based on user movement indicated by available head tracking data. In another aspect, the configuration parameters may indicate that the audio playback is to be fixed, meaning that spatial audio data is not to be modified based on head movements by the user (e.g., captured head tracking data). Thus, the controller 200 may be configured to determine whether the output device 110 is configured to be fixed or enable head tracking during audio playback. If fixed, the audio data is not to be modified by the controller 200 based on received head tracking data. Otherwise, if audio output by the output device 110 is configured for head tracking, the controller 200 may modify the audio data based on the head tracking data.

At block 302, the cable is disconnected. For example, when the source device 120 is a stationary electronic device, such as a desktop computer, the user may disconnect (or unplug) the cable so that the user may move about the environment with the output device 110, which may still be donned (worn) on the user's head. The controller 200 of the source device 120 determines that the wired connection has been terminated (at block 315), and (e.g., begins to cause the source device 120 to) wirelessly transmit the audio data to the output device 110 through the wireless connection 130. In which case, in response to determining that the wired connection 140 is no longer established, the (e.g., audio distributor 240 of the) controller 200, without user intervention, may cease transmitting the audio data through the wired interface 270 and may continue to transmit the audio data through the wireless connection 130 (which may also be used by the system to exchange the control data) to the output device. In one aspect, the source device may process (e.g., encode and packetize) the audio data for wireless transport, and as a result, the audio data wirelessly transmitted may be of lower quality than that sent over the cable, which is a lossless connection thereby allowing for more high-quality data. In another aspect, rather than transmitting the audio data over the existing wireless connection, the system may establish a second wireless connection for audio data transport, such as an A2DP BLUETOOTH connection. In another aspect, the controller 201 of the output device may determine that the wired connection has been terminated (at block 315). In particular, upon determining that no audio data is being received through the wired connection, the controller 201 may be configured to accept audio data through the wireless connection. As a result, the controller 201 may be configured to continue audio playback using the wirelessly transmitted audio data. In another aspect, the output device may indicate that it is accepting new incoming wireless connections, based on which the devices may establish another wireless connection for transmitting audio data to the output device. This indication may be wirelessly transmitted, via the established wireless connection, to the source device.

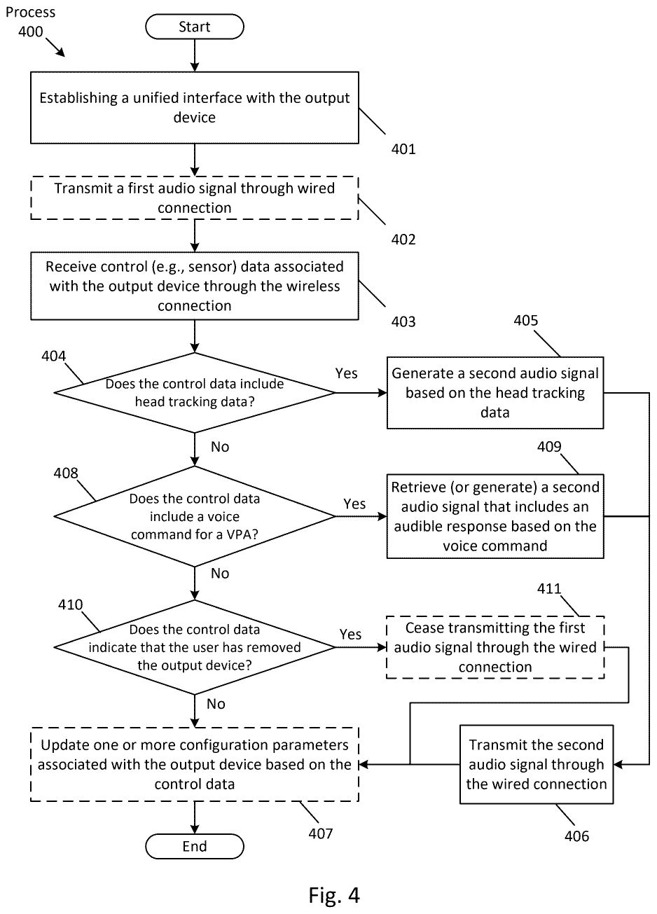

FIG. 4 is a flowchart of one aspect of a process 400 of the source device 120 performing signal processing operations based on control data received from the output device 110 over a wireless connection of a unified communication interface. The process 400 begins with the source device 120 establishing a unified interface 101 with the output device 110 (at block 401). In particular, the unified communication interface 101 may be established by both devices communicatively coupling to one another via a wireless connection and a wired connection, whereby either connection may be established first or the connections may be established (e.g., approximately) simultaneously (e.g., when a cable is connected by the user to communicatively coupled both devices together). The controller 200 transmits a first audio signal through the wired connection to the output device (at block 402). In one aspect, the transmission of the first audio signal may be in response (e.g., without user intervention) to the establishment of the wired connection. In another aspect, the signal may be transmitted in response to user input (e.g., through the client application 220). In some aspects, block 402 may be optional.

The controller 200 of the source device 120 receives control (e.g., sensor) data associated with the output device 110 through the wireless connection (at block 403). In particular, the output device may transmit control data that may include data captured by one or more sensors 710, may be based on at least some sensor data, or may be based on user input at (e.g., through one or more controls of) the output device. For instance, the output device may receive a microphone signal captured by a microphone of the output device, where the microphone signal may include a voice command spoken by the user of the output device. The voice command may be transmitted as the control data through the wireless connection. In another aspect, the controller 201 of the output device may determine whether it has been removed from the user's head. Specifically, the controller 201 may receive sensor data from a sensor, such as a proximity sensor, of the output device, and may determine whether the output device is being or has been removed from the head of the user based on proximity sensor data. Such a determination may be based on whether the proximity sensor data indicates that an object (e.g., the user's head) has moved beyond a threshold distance from the output device. In response, the output device may transmit a notification as control data, which indicates that the output device is being or has been removed. Other sensor data may include head tracking data based on one or more motion sensors (e.g., IMUs) of the output device. In another aspect, the control data may indicate an operational mode (of several operational modes) in which the output device is operating. For instance, the user of the output device may switch (or activate) an operational mode (e.g., whether operating ASE mode or ANC mode) at the output device, and in response, the output device may transmit control data that indicates the (current) operational mode of the output device to the source device.

The controller 200 of the source device 120 determines whether the control data includes head tracking data (at decision block 404). In one aspect, this decision may also be based on whether the source device is streaming audio data (e.g., as the first audio signal), which may include spatial audio, to the output device 110. If so, the controller 200 may generate (or produce) a second audio signal based on the head tracking data (at block 405). In particular, the controller 200 may be configured to spatially render the audio data according to the (most recently received) head tracking data in order to account for movement of the user's head. For instance, if the spatial audio data includes a sound source that is to be rendered such that the user perceives the sound source from a right-hand side of the user, and the movement of the user is a head movement towards the left-hand side of the user, the sound source may be (e.g., proportionally) moved towards the right-hand side based on the head movement indicated in the head tracking data. The controller 200 causes the source device 120 to transmit the second audio signal through the wired connection to the output device 110 (at block 406). In response, the controller 201 of the output device may use the second audio signal (instead of the first audio signal) to drive one or more speakers of the output device for audio playback. The controller 200 may be configured to (optionally) update one or more configuration parameters associated with the output device 110 based on the control data (at block 407). For instance, the client application 220 may provide the control center 230 with positional data (e.g., position and/or orientation) associated with the user's head based on the head tracking data, which may be used to continue to spatially render audio content.

If, however, the control data does not include head tracking data, the controller 200 may be configured to determine whether the control data includes a voice command for a VPA (at block 408). As described herein, the wireless connection may be a bi-directional wireless connection, such as a Hands-Free Protocol (HFP) BLUETOOTH connection in which audio data may be exchanged between the source device and the output device. In which case, the output device may capture, using a microphone of the output device, speech of the user, which may include a voice command, and transmit the speech as the control data. The controller 200 may be configured to determine whether the speech includes the voice command (e.g., by performing a speech recognition algorithm), and if so may be configured to retrieve (or generate) a second audio signal that includes an audible response based on the voice command (at block 409). For instance, a VPA application executing on the source device may generate the audible response, or may transmit (e.g., via a network) the voice command to a remote server, which may generate and provide the audible response as the second audio signal. The controller 200 may cause the source device 120 to transmit the second audio signal through the wired connection for playback by the output device, and may update one or more configuration parameters. As a result, the output device 110 may receive the second audio signal that includes an audible response to the voice command, and may drive one or more speakers using the signal to audibly reproduce the audible response.

If, however, the control data does not include a voice command for a VPA, the controller 200 may be configured to determine if the control data indicates that the user of the output device 110 has removed (or is in the process of removing) the output device (at block 410). In one aspect, this indication may be generated by the controller 201 of the output device based on sensor data of one or more sensors, such as a proximity sensor. For instance, the proximity sensor may produce sensor data that indicates that the output device is being removed from the user's head, and in response, the output device may provide a notification that the output device is no longer on the user's head as control data. If so, and if the controller 200 has been causing the source device to transmit the first audio signal, the controller 200 may cause the source device to cease transmitting the first audio signal through the wired connection (at block 411). In some aspects, the client application 220 may pause audio streaming until one or more conditions are met. For example, the client application 220 may begin to stream the first audio signal in response to receiving control data that indicates that the user has put the output device back on the user's head (e.g., based on proximity sensor data). In which case, the controller 200 may be configured to (e.g., continuously) monitor control data for an indication that the output device has been placed on the user's head. For example, the sensors of the output device may determine whether an object is within a threshold distance, where the object may be a part of the user's anatomy (e.g., side of the user's head). If so, the output device may transmit a notification, through the wireless connection to the source device. In which case, the system 100 may keep the wireless connection active in order for both devices to continue to exchange control data.

If, however, the control data does not indicate that the user has removed the output device, the controller 200 may update one or more configuration parameters at block 407. In particular, the control data may indicate changes to one or more configuration parameters, whereby the control center may update the parameters (e.g., in memory). For example, the control data may include an indication of (e.g., a change to) an operational mode in which the output device is operating. In which case, the control center 230 may indicate (or update) the change in memory. Specifically, the control center may update, in memory, a configuration parameter (that may indicate what mode the output device is operating) of the output device responsive to a reception of the indication.

In one aspect, the updated configuration parameters may be viewable by a user of the source device. For instance, the control center 230 may be configured to display the updated configuration parameter of the output device in a GUI on a display (e.g., display 730 of FIG. 7) of the source device 120. In some aspects, the user of the source device may be able to adjust features of the output device through the control center 230. For example, while the updated configuration parameter is displayed in the GUI, the source device may receive a user input to change the parameter. As an example, the control center 230 may indicate in the GUI that the output device is operating in ASE mode. The controller 200 may receive user input to select a different mode, such as ANC mode, for the output device to operate. In response, the control center 230 may provide control data 280 to the audio distributor 240, for it to cause the source device 120 to transmit, via the wireless connection 130, the control data to the output device for the controller 201 to configure its operational mode.

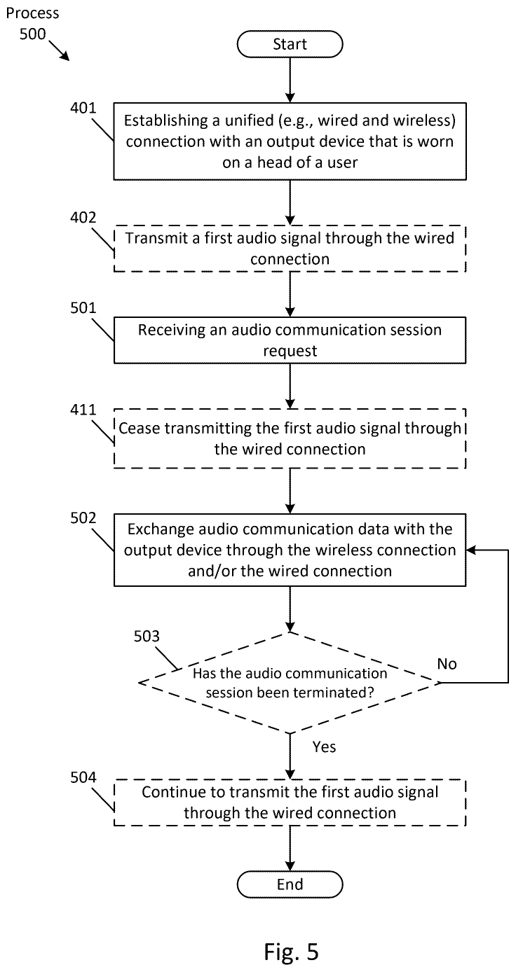

FIG. 5 is a flowchart of one aspect of a process 500 to switch between the wired connection and the wireless connection for establishing and conducting an audio communication session. The process 500 begins with the system 100 establishing the unified connection with the output device 110 that is worn on a head of the user (at block 401). For instance, the controller 200 of the source device 120 may establish, while communicatively coupled via a wired connection with the output device, a wireless connection 130 between the devices. In one aspect, the source device or the output device may initiate the establishment of the wireless connection. The controller 200 may optionally cause the source device 120 to transmit a first audio signal through the wired connection to the output device for audio playback (at block 402). The controller 200 receives an audio communication session request (at block 501). For instance, a telephony application of the source device 120 may receive a request via a network (through the network interface) from a remote device. In one aspect, the remote device may be any electronic device capable of establishing an audio communication session, such as a smart phone. In another aspect, the request may be received through the source device. For example, the telephony application may receive user input (e.g., a user selection of a user interface (UI) item on a GUI displayed on a display of the source device) for the source device to initiate the communication session with a remote device. The controller 200 may cause the source device to cease transmitting the first audio signal through the wired connection (at block 411). In which case, the controller 201 may cause the output device to cease driving one or more speakers to reproduce sound due to no longer receiving the audio data from the source device. If the source device is not already transmitting the first audio signal to the output device, block 411 may be optional.

The controller 200 causes the source device 120 to exchange audio communication data with the output device through the wireless connection and/or the wired connection (at block 502). In particular, the source device may establish the audio communication session with the remote device by exchanging session data. For example, (e.g., responsive to the source device accepting the communication session request, which may be based on user input through the source device) the controller 200 of the source device 120 may receive, via a network, a downlink audio signal that includes audio communication data from a remote device with which the communication session is established, and may (cause the source device to) transmit the downlink signal through the wired connection for audio playback through one or more speakers of the output device. The controller 200 may receive, from the output device, an audio signal that includes speech of the user and may transmit the audio signal as an uplink audio signal (through the network) to the remote device. In particular, the uplink signal may be produced based on a microphone signal captured by a microphone of the output device. In one aspect, the uplink signal may be received by the source device through the established wireless connection from the output device. Thus, responsive to the controller 200 accepting the communication session request, the (e.g., audio distributor 240 of the) controller 200 may cease transmission of the audio data to the headset through the wired connection, and the controller 200 may cause audio communication data to be exchanged between the headset through the wireless connection (and/or wired connection) and the remote device through the network. In another aspect, the system 100 may establish another (a second) wireless connection, which may be used for communication session data. For instance, once the communication session is established, the source device 120 may establish a second wireless connection with the output device, which may be used to receive speech data from the output device. This new connection may be a uni-directional audio connection, such as an A2DP BLUETOOTH connection, or it may be a bi-directional wireless connection. For example, the system 100 may establish the second wireless connection, which may be used for audio communication between at least two devices, such as HFP BLUETOOTH connection. In another aspect, the audio communication data may be exchanged through only the wireless connection. For instance, the wireless connection may be a bi-directional wireless connection, such as an HFP Bluetooth connection. Thus, the source device may act as an intermediary device that passes audio communication data between the remote device and the output device through the wired connection and the wireless connection.

The controller 200 determines whether the audio communication session has been terminated (at decision block 503). For instance, the controller 200 may determine whether user input to terminate the session has been received through a GUI of the telephony application executing on the source device 120. If so, the source device may cease transmitting audio communication session data through the wired connection and may continue to transmit the first audio signal through the wired connection (at block 504). Specifically, once the audio communication session has been terminated, the system 100 may continue streaming audio data that had been streaming before the audio communication session was established. In another aspect, the system may break down any additional wireless connection that was used during the audio communication session.

As described herein, the wireless connection may be a bi-directional wireless connection. In which case, the system 100 may exchange data through the wireless connection 130 based on one or more criteria. For example, upon determining that the wired connection has been disconnected, the (e.g., audio distributor 240 of the) source device 120 may begin to transmit the uplink audio signal through the wireless connection in order to seamlessly transition from the wired connection to the wireless connection without user intervention. In other words, if the wired connection is broken, the system may seamlessly (without user intervention) exchange audio communication session data through one or more wireless connections in order to continue the session without any apparent interruptions by the users.

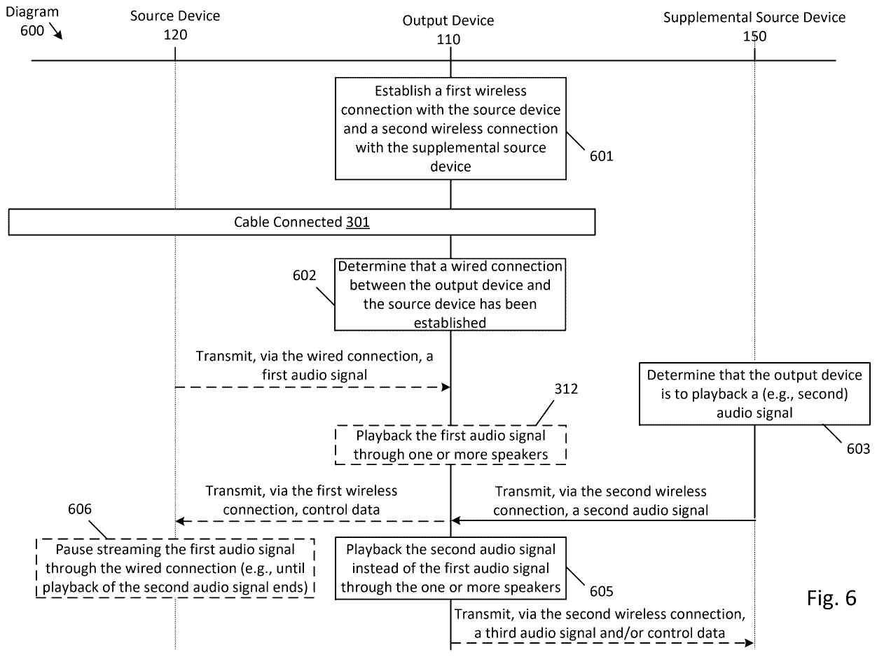

FIG. 6 is a signal diagram 600 of one aspect to switch between connections between multiple electronic devices to playback audio data at the output device. In particular, the system 100 may switch between connections by transitioning between one or more wired and/or wireless connections for transmitting audio data to the output device 110 for playback. The diagram 600 begins with the output device 110 establishing a first wireless connection with the source device 120 and a second wireless connection with the supplemental source device 150 (at block 601). In particular, the devices may engage in a discovery mode in which the electronic devices wirelessly broadcast their presence to other devices that are capable of establishing wireless connections. In which case, one or more of the devices may enter this mode to receive wireless credentials from the other devices. For example, the source device 120 and the supplemental source device 150 may enter a discovery mode in order to receive wireless credentials from the output device 110, thereby pairing the output device with both devices. In one aspect, the devices are paired such that they are aware of each over, having shared credentials, but are not yet actively exchanging data. In another aspect, upon pairing with at least one of the devices, the output device 110 may exchange data via a wireless connection with the at least one device.

In one aspect, although block 601 is illustrated as being performed by the output device 110, at least some of these operations may be performed by the source device 120 and/or the supplemental source device 150. For instance, the supplemental source device 150 may establish a wireless connection with the output device 110, which may be performed automatically (e.g., where the device(s) may enter discovery mode without user intervention), or may be based on user input at the output device 110 and/or the supplemental source device 150. In which case, this wireless connection may be established while (or before) the output device 110 is communicatively coupled with the source device 120 via a wired and/or wireless connection such that the output device may be configured to receive one or more audio signals via the wired (or established wireless) connection(s) for audio playback.

A cable is connected to both the source device 120 and the output device 110 (at block 301). The controller 201 of the output device 110 determines that the wired connection between the output device and the source device 120 has been established (at block 602). In one aspect, in response to determining that the devices are connected through the cable, the controller 201 may cause the output device to transmit a message through the wired connection indicating that such a connection has been established, along with other information. For example, the output device may transmit credentials (e.g., a unique identifier) associated with the output device in order to ensure that any wirelessly exchanged data occurs through the first wireless connection. Thus, upon the establishment of the wired connection, the first wireless connection, the second wireless connection, and the wired connection may be contemporaneously active to allow the output device to exchange data with either (or both) of the source device or the supplemental source device individually and/or simultaneously. Thus, the output device may remain communicatively coupled by maintaining its connections (wired and/or wireless) with the source device and supplemental source device, even if none of the devices are exchanging data between each other. For example, the devices may maintain persistent connections by exchanging empty data packets (e.g., keep-alive packets), until data, such as audio data, is to be exchanged between devices. This may allow the output device to exchange data with one device via one or more connections, and switch to exchange data with the other device via one or more respective connections in a seamless manner.

The source device 120 transmits, via the wired connection, a first audio signal, and the controller 201 of the output device 110 plays back the first audio signal through one or more speakers (at block 312). As described herein, the output device may receive audio data through the wired connection due to the wired connection having a lower latency and higher bit rate than a wireless connection, such as a BLUETOOTH connection. This allows the output device to playback high quality audio, since less compression is necessary for wired transmission than wireless transmission. The output device (optionally) transmits, via the first wireless connection control data. For example, the control data may indicate the operational mode of the output device, or it may include playback commands, such as a pause command when the first audio signal includes audio content of a media playback application executing on the source device.

The (e.g., controller of the) supplemental source device 150 determines that the output device is to playback a (e.g., second) audio signal (at block 603). In one aspect, this determination may be done while the headset is communicatively coupled with the source device 120 via the wired connection 140 and the wireless connection 130, contemporaneously. This determination may be based on user input. For example, the supplemental source device 150 may receive user input from the user of the output device to play back a piece of audio content, such as a musical composition. Thus, the supplemental source device 150 may transmit audio content responsive to a reception of the user input. As another example, the user may wish to initiate an audio communication session between the supplemental source device and the output device. In particular, the supplemental device may be a wireless electronic device that is capable of performing communication sessions, such as a smartphone. In which case, the supplemental source device 150 may receive an indication that an audio communication session is to be initiated with a remote electronic device. For example, the user may initiate (e.g., through a telephony application executing on the supplemental source device 150) an audio communication session (e.g., telephone call). For instance, the supplemental source device may display a GUI of the telephony application, where user input may be received through user contact with a touch-sensitive display screen of the source device of a user interface (UI) item in the GUI. As another example, the indication may be based on receiving an audio signal (e.g., downlink signal) received via a network from the remote device. As a result, the system 100 may use the output device to perform the communication session through the supplemental source device 150.

As a result, the supplemental source device 150 transmits, via the second wireless connection, the second audio signal to the output device 110. This audio data may be transmitted while at least one of the wired connection and the wireless connection between the output device 110 and the source device 120 are maintained. The controller 201 plays back the second audio signal instead of the first audio signal through the one or more speakers (at block 605). In particular, the controller 201 may cease (or pause) audio playback of the first audio signal, and begin to playback the second audio signal in lieu of the first audio signal. In one aspect, these operations may be performed automatically, without user intervention. As a result, the output device 110 may be configured to playback one (or both) audio signals, while maintaining one or both of the established wireless connections.

Thus, while the wired connection 140 remains established between the source device 120 and the output device 110, the output device may playback audio content received from another device. In particular, the output device may switch from using audio data received through the wired connection to using audio data received through the second wireless connection for sound playback. The output device receives, through the second wireless connection, audio data from the supplemental source device and plays back the audio data through one or more speakers instead of the audio data from the source device 120. In another aspect, the output device may begin audio playback once audio data is received from the supplemental source device 150. For example, operations of block 312 may be optional, and as a result, the output device may have an established unified communication interface with the source device 120, but may not be playing back audio content. As a result, the source device may continue to receive control data from the output device, without providing audio for playback to the output device, which may be the case if a user has paused audio playback through a GUI of a media application on the source device 120, for example.

In one aspect, the output device 110 may be configured to transmit data to the supplemental source device 150. For example, in the case in which the second audio signal includes audio data of an audio communication session, the output device may be configured to capture, using a microphone of the output device, a microphone signal that includes speech data of the user of the output device, and transmit the microphone signal (e.g., as a third audio signal) that includes speech data of a user of the output device 110 to the supplemental source device such that a user may perform the audio communication session using the output device 110 and through the supplemental source device 150 (which may exchange audio data between the output device and one or more remote electronic devices that are engaged in the audio communication session via one or more networks). In one aspect, the microphone signal may be transmitted through the second wireless connection, when the connection is a bi-directional wireless connection. In another aspect, the output device may transmit the microphone signal through another (e.g., a third) wireless connection established between the supplemental source device and the output device. In another aspect, the output device 110 may be configured to transmit any sensor data and/or control data to the supplemental source device 150, as described herein, which may be used by the supplemental source device to modify or adjust the audio of the second audio signal.

As a result, the output device 110 may remain wirelessly connected (and connected through a cable) to the source device 120, while actively communicating with the supplemental source device 150 through one or more wireless connections. This transition between wirelessly communicating between one or more source devices may be performed seamlessly by the output device, thereby not no requiring user intervention. In particular, the system may automatically switch between the source device 120 and the supplemental source device 150 without requiring the user to manually unpair the output device from the source device and then manually pair the output device with the supplemental source device in order to establish and communicate wirelessly.

The source device 120 may pause streaming of the first audio signal (e.g., which may include user-desired audio content, such as a musical composition) through the wired connection (at block 606). In one aspect, the source device may receive, from the output device 110, control data through the first wireless connection indicating that the source device is to pause or stop the streaming (due to the system wanting to playback the second audio signal). In particular, the source device may pause or stop the streaming, responsive to receiving the control data through the first wireless connection from the output device. In some aspects, the source device may pause or stop audio streaming until playback of the second audio signal by the output device ends. In which case, once the playback of the second audio signal ends (e.g., the audio communication session with the supplemental device has ended), the output device may transmit, via the first wireless connection, an indication to resume audio streaming.

In another aspect, the system 100 may be configured to determine whether the supplemental source device 150 is to transmit audio data for audio playback at the output device based on other criteria. As described herein, the supplemental source device 150 may stream audio data based on user input (e.g., the user's desire to establish an audio communication session) at the supplemental device 150. In another aspect, the supplemental source device 150 may stream audio data based on whether the output device 110 is connected with the source device 120. In particular, the supplemental source device may be configured to transmit the first audio signal in response to the wired connection 140 between the source device and the output device being terminated. For example, upon determining that the wired connection is disconnected, the output device may transmit control data to the source device to continue streaming the audio through the first wireless connection. In another aspect, the output device may transmit a request (e.g., as control data) to the supplemental source device for the device to wirelessly stream the audio data (e.g., same audio data that was streamed through the wired connection) through the second wireless connection (instead of the source device). This may be the case based on one or more criteria. For instance, the output device may transmit the request responsive to the wired connection being disconnected. As another example, the controller 201 of the output device may determine which wireless connection is the most optimal connection for wirelessly streaming the audio data. For instance, the controller 201 may measure the signal strength of both wireless connections, and select the wireless connection with the best (highest) signal strength to stream the audio data. Once selected, the controller 201 may transmit a control signal to the electronic device with the highest signal strength (e.g., above a threshold) to transmit audio data, and/or may transmit a control signal to the other device with a lower signal strength (e.g., below a threshold) to cease audio data transmission. As a result, in response to the wired connection being disconnected, the output device may receive the audio data from the source device through its wireless connection, determine which audio signal is to be used based on the wireless connections, and in response use audio data received through at least one of the wireless connections. Therefore, the system may use the best wireless connection for exchanging audio data. As a result, the system may switch between devices for audio streaming in a seamless manner. For example, the system may switch audio streaming from one source device to another without any disruptions during audio playback.

As described, the controller 201 of the output device 110 may be configured to determine which wireless connection is to be used for streaming audio. In another aspect, this determination may be made by the supplemental source device 150 and/or the source device 120. For example, the output device 110 (or the source device 120) may be configured to transmit wireless characteristics (e.g., signal strength) of their wireless connection to the supplemental source device, which may be configured to determine which wireless connection is to be used to stream audio to the output device. Upon making a determination, the supplemental source device may be configured to instruct the source device (e.g., through the output device or through a separate wireless connection) to either stream the audio or pause audio transmission based on whether the supplemental device is to stream the audio or not, respectively. As a result, the supplemental source device may be configured to transmit control data to the source device 120 in order to instruct the source device whether to pause audio streaming or to continue audio streaming.

In another aspect, the supplemental source device may begin to transmit audio data responsive to the wired connection being disconnected. For instance, once disconnected, the source device (or the supplemental source device) may either determine which of multiple wireless connections are to be used for audio streaming, or may begin to transmit audio through multiple wireless connections for the output device to make a determination of which audio to use based on one or more criteria (e.g., based on the signal strength of the corresponding wireless connection through which the audio data is received). In another aspect, the output device may be configured to determine which of the wireless connections is to be used for audio streaming.

In one aspect, once the supplemental source device 150 no longer streams the second audio signal (e.g., due to user input at the supplemental source device), the supplemental source device may remain wirelessly connected to the output device 110, while the output device may stream audio from either the original source device 120 or the supplemental source device 150.

In some aspects, the system may switch between electronic devices for audio streaming. As described herein, the system 100 may wirelessly stream audio from the supplemental source device 150 to the output device 110, responsive to the wired connection 140 being disconnected. In one aspect, upon determining that the wired connection is reestablished between the source device 120 and the output device 110, the system 100 may be configured to stream the audio through the wired connection instead of the wireless connection. In another aspect, the system may switch between devices based on user input. As described herein, the supplemental device may be configured to determine that the output device is to playback audio content, which may be responsive to user input (e.g., to engage in a communication session). The source device 120 may be configured to determine that the output device is to playback audio responsive to other user input received at or by the source device. As a result, the system may (e.g., wirelessly) stream audio content from the source device 120 in response to the subsequent user input for audio playback by the output device. In addition, the (e.g., source device 120 of the) system may be configured to cause the supplemental source device to pause audio transmission responsive to the subsequent user input.

In another aspect, the system may switch wireless communication between multiple source devices. For example, the output device may establish wireless connections with one or more source devices, and may transition between exchanging audio data and/or control data with the devices. This transition may be based on the output device's proximity to the source devices, or may be based on user input at a source device or at the output device. Thus, the determination as to which source devices are providing audio data to the output device may be performed (e.g., by software and/or hardware) on one or more of the source devices. For example, while the output device wirelessly streams audio from a first source device (e.g., the supplemental source device 150), the output device may wirelessly connect to a second source device. The system 100 (e.g., the supplemental source device 150) may be configured to determine which of the two source devices is to wirelessly stream the audio (e.g., based on signal strength), and may be configured to cause one of the source devices to stream the audio to the output device. As a result, the system 100 may seamlessly switch audio streaming between multiple source devices. In another aspect, this determination may be performed at the output device 110.

In one aspect, at least some of the operations described herein may be optionally performed by the system 100 when establishing and managing data communication connections (e.g., wired and/or wireless connections) described herein. Specifically, at least some dashed blocks and lines illustrated in FIGS. 1 and 3-6 may be optionally performed by the system 100. For example, block 312, block 313, block 314, and/or block 315 in FIG. 3 may be optionally performed when the unified communication interface is established. At least some data transmission may be optional. For example, referring to FIG. 6, the transmission of the first audio signal from the source device 120 to the output device 110, the transmission of the control data from the output device 110 to the source device 120, and/or the transmission of the third audio signal and/or control data from the output device 110 to the supplemental source device 150 may be optional.

FIG. 7 shows a block diagram of audio processing system hardware, in one aspect, which may be used with any of the aspects described herein, such as the source device 120, the supplemental source device 150, and/or the output device 110 of system 100. This audio processing system can represent a general-purpose computer system or a special purpose computer system. Note that while FIG. 7 illustrates the various components of an audio processing system that may be incorporated into one or more of the devices described herein, it is merely one example of a particular implementation and is merely to illustrate the types of components that may be present in the system. FIG. 7 is not intended to represent any particular architecture or manner of interconnecting the components as such details are not germane to the aspects herein. It will also be appreciated if other types of audio processing systems that have fewer components than shown or more components than shown in FIG. 7 can also be used. Accordingly, the processes described herein are not limited to use with the hardware and software of FIG. 7.

As shown in FIG. 7, the audio processing system (or system) 100 (for example, a laptop computer, a desktop computer, a mobile phone, a smartphone, a tablet computer, a smart speaker, a head-mounted display (HMD), a (wireless) headphone (headset, such as an earbud), or an infotainment system for an automobile or other vehicle) includes one or more buses 740 that serve to interconnect the various components of the system. One or more processors 770 are coupled to bus 740 as is known in the art. The processor(s) may be microprocessors or special purpose processors, system on chip (SOC), a central processing unit, a graphics processing unit, a processor created through an Application Specific Integrated Circuit (ASIC), or combinations thereof. Memory 760 can include Read Only Memory (ROM), volatile memory, and non-volatile memory, or combinations thereof, coupled to the bus using techniques known in the art. The sensor(s) 710, speaker(s) 720, and display(s) 730 may be coupled to the bus. In one aspect, one or more components of the system 100 may be optional, such as the display.

The sensor(s) 710 may include one or more electronic devices (or components) that are designed to produce sensor data that indicates one or more aspects (or features) of an environment in which the sensors are located. For example, the sensors may include an image capture device, such as a camera that may be configured to capture image data (video and/or still images) that includes one or more images of a field of view of the camera. The sensors may include a proximity sensor (e.g., an optical proximity sensor) that may be configured to determine a proximity (distance) of one or more objects within the environment. The sensors may include a motion sensor that are configured to detect motion within the environment. In another aspect, the sensors may include a motion sensor, such as an accelerometer or an inertial measurement unit (IMU), which may be configured to monitor motion of a device in which the motion sensor is integrated. In another aspect, the sensors may include one or more microphones that are configured to capture sound as one or more microphone signals. In another aspect, the sensor may include a positional sensor that may be designed to determine (or identify) a location of the sensor, such as a Global Positioning System (GPS) sensor.

In one aspect, one or more of the sensors may be a part of or integrated with at least one device of the system 100. For example, the output device 110 may include at least one of a proximity/motion sensor, a camera, and/or one or more microphones. In which case, when the output device is a headset, the headset may include an error (or “internal”) microphone that is arranged to capture sound (and/or sense pressure changes) inside a user's ear (or ear canal), while the headset is worn on a head of the user. The headset may include a reference (or “external”) microphone arranged to capture sound from the ambient environment in which the headset is located.

In another aspect, at least one of the sensors 710 may be a part of another electronic device, such as the source device 120. In the case in which the output device is performing the operations described herein, sensors of the source device 120 may transmit sensor data (e.g., via the wireless connection 130) to the output device to perform digital signal processing operations, as described herein. As an example, the output device 110 may be configured to perform audio processing operations upon a microphone signal captured by a microphone of the output device, or a microphone of another electronic device (e.g., source device) that may be configured to transmit (e.g., either through a wired or wireless connection) the signal to the output device.

Memory 760 can be connected to the bus and can include DRAM, a hard disk drive or a flash memory or a magnetic optical drive or magnetic memory or an optical drive or other types of memory systems that maintain data even after power is removed from the system. In one aspect, the processor 770 retrieves computer program instructions stored in a machine-readable storage medium (memory) and executes those instructions to perform operations described herein.

Audio hardware, although not shown, can be coupled to the one or more buses 740 in order to receive audio signals to be processed and output (played back) by speakers 720. Audio hardware can include digital to analog and/or analog to digital converters. Audio hardware can also include audio amplifiers and filters. The audio hardware can also interface with one or more sensors 710, such as microphones (e.g., microphone arrays) to receive audio signals (whether analog or digital), digitize them if necessary, and communicate the signals to the bus 740.

The network interface 750 may communicate with one or more electronic devices and networks. As described herein, the network interface may include a wireless interface 260 and a wired interface 270 for establishing a wireless connection and a wired connection, respectively, with one or more electronic devices to exchange data. For example, the wireless interface may communicate over any known technologies such as Wi-Fi, 3G, 4G, 5G, Bluetooth, ZigBee, or other equivalent technologies. The wired interface may communicate through any cable and using any wired communication protocol, as described herein. In which case, the network interface can include wired or wireless transmitters and receivers that can communicate (e.g., receive and transmit data) with networked devices such as servers (e.g., the cloud) and/or other devices, such as any devices of system 100 and/or other devices (e.g., remote speakers and remote microphones).

It will be appreciated that the aspects disclosed herein can utilize memory that is remote from the system, such as a network storage device which is coupled to the audio processing system through a network interface such as a modem or Ethernet interface. The buses 740 can be connected to each other through various bridges, controllers, and/or adapters as is well known in the art. In one aspect, one or more network device(s) can be coupled to the bus 740. The network device(s) can be wired network devices (e.g., Ethernet) or wireless network devices (e.g., Wi-Fi, BLUETOOTH). In some aspects, various aspects described herein may be performed by a networked server in communication with one or more devices of the system 100.

In some aspects, the system 100 may perform at least some of the operations described herein using a machine learning (ML) model. For instance, operations to manage and monitor wireless and wired interfaces may be performed by the ML model, whereby the ML model may determine whether to switch between the interfaces responsive to control (e.g., sensor) data as input, for example.

According to one aspect of the disclosure, a method performed by an electronic device, that includes: establishing, while communicatively coupled via a wired connection with a headset worn on a head of a user, a wireless connection between the electronic device and a headset; receiving, via a network, a communication session request from a remote device; responsive to accepting the communication session request, receiving, via the network, a downlink audio signal; transmitting, via the wired connection, the downlink audio signal to the headset for audio playback; receiving, via the wireless connection and from the headset, an audio signal that includes speech of the user; and transmitting, via the network, the audio signal as an uplink audio signal to the remote device.

In one aspect, the wireless connection is established before the communication session request is received. In another aspect, the wireless connection is established responsive to the accepting of the communication session request. In some aspects, the wireless connection is a bi-directional wireless connection, where the method further includes determining that the wired connection has been disconnected; and in response, transmitting, via the bi-directional wireless connection, the downlink audio signal to the output device along with receiving the audio signal through the bi-directional wireless connection. In another aspect, the bi-directional wireless connection is a Hands-Free Protocol (HFP) BLUETOOTH connection.

According to an aspect of the disclosure, a method performed by a programmed processor of a first electronic device, the method includes: determining that a headset that is worn by a user is to play back a first audio signal, where the headset is communicatively coupled with a second electronic device via a wired connection and a first wireless connection, contemporaneously, where the second electronic device is configured to transmit a second audio signal through the wired connection to the headset for audio playback through at least one speaker of the headset, and the second electronic device and the headset are configured to exchange control data through the first wireless connection; transmitting, via a second wireless connection, the first audio signal to the headset for audio playback through the at least one speaker, while at least one of the wired connection and the first wireless connection between the headset and the second electronic device is maintained.

In one aspect, determining includes receiving user input to initiate the audio playback of audio content, where the first audio signal that comprises the audio content is transmitted responsive to a reception of the user input. In another aspect, determining includes receiving, via the first wireless connection, a control signal to cause the first electronic device to provide the first audio signal, where the control signal is received responsive to the wired connection between the headset and the second electronic device being disconnected. In some aspects, the first audio signal and the second audio signal includes a same audio content. In another aspect, the second wireless connection includes a bi-directional wireless connection, where determining includes receiving an indication that an audio communication session is to be initiated with a remote electronic device, where the first audio signal includes speech data from the remote electronic device, where the method further includes receiving, via the second wireless connection, a third audio signal that includes speech data of the user of the headset for transmission to the remote electronic device, via a network. In some aspects, the first electronic device includes a portable electronic device, and the second electronic device includes a stationary electronic device.

Various aspects described herein may be embodied, at least in part, in software. That is, the techniques may be carried out in an audio processing system in response to its processor executing a sequence of instructions contained in a storage medium, such as a non-transitory machine-readable storage medium (e.g., DRAM, hard disk drive, or flash memory). In various aspects, hardwired circuitry may be used in combination with software instructions to implement the techniques described herein. Thus, the techniques are not limited to any specific combination of hardware circuitry and software, or to any particular source for the instructions executed by the audio processing system.

In the description, certain terminology is used to describe features of various aspects. For example, in certain situations, the terms “application,” “layer” “controller,” “component,” “unit,” “module,” “logic,” “filter,” “encoder,” “decoder,” “mixer,” “renderer,” “center,” “distributor,” “interface,” “algorithm,” and “processor” are representative of hardware and/or software configured to perform one or more processes or functions. For instance, examples of “hardware” include, but are not limited or restricted to an integrated circuit such as a processor (e.g., a digital signal processor, microprocessor, application specific integrated circuit, a micro-controller, etc.). Thus, different combinations of hardware and/or software can be implemented to perform the processes or functions described by the above terms, as understood by one skilled in the art. Of course, the hardware may be alternatively implemented as a finite state machine or even combinatorial logic. An example of “software” includes executable code in the form of an application, an applet, a routine or even a series of instructions. As mentioned above, the software may be stored in any type of machine-readable medium.

Some portions of the preceding detailed descriptions have been presented in terms of algorithms and symbolic representations of operations within a computer memory. These algorithmic descriptions and representations are the ways used by those skilled in the audio processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of an audio processing system, or similar electronic device, that manipulates and transforms data represented as physical (electronic) quantities within the system's registers and memories into other data similarly represented as physical quantities within the system memories or registers or other such information storage, transmission or display devices.

The processes and blocks described herein are not limited to the specific examples described and are not limited to the specific orders used as examples herein. Rather, any of the processing blocks may be re-ordered, combined, or removed, performed in parallel or in serial, as necessary, to achieve the results set forth above. The processing blocks associated with implementing the audio processing system may be performed by one or more programmable processors executing one or more computer programs stored on a non-transitory machine-readable storage medium to perform the functions of the system. All or part of the audio processing system may be implemented as special purpose logic circuitry (e.g., an FPGA (field-programmable gate array) and/or an ASIC (application-specific integrated circuit)). All or part of the audio system may be implemented using electronic hardware circuitry that include electronic devices such as, for example, at least one of a processor, a memory, a programmable logic device or a logic gate. Further, processes can be implemented in any combination of hardware devices and software components.

As previously explained, an aspect of the disclosure may be a non-transitory machine-readable medium (such as microelectronic memory) having stored thereon instructions, which program one or more data processing components (generically referred to here as a “processor”) to perform audio signal processing operations, such as establishing a unified interface having wireless and wired connections and switching between connections, other network operations, and other audio signal processing operations, as described herein. In other aspects, some of these operations might be performed by specific hardware components that contain hardwired logic. Those operations might alternatively be performed by any combination of programmed data processing components and fixed hardwired circuit components.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method performed by a headset, the method comprising:
establishing a first wireless connection between a first electronic device and the headset that is worn on a head of a user;
establishing a second wireless connection between a second electronic device and the headset;
receiving, via a wired connection with the first electronic device, a first audio signal for audio playback through at least one speaker of the headset;
receiving, via the second wireless connection, a second audio signal from the second electronic device; and
responsive to receiving the second audio signal and without user intervention, using the second audio signal for audio playback through the at least one speaker of the headset in lieu of the first audio signal.

2. The method of claim 1 further comprising:
transmitting, via the first wireless connection and to the first electronic device, control data indicating that the audio playback of the first audio signal is to be paused or stopped; and
responsive to transmitting the control data, ceasing to receive the first audio signal through the wired connection.

3. The method of claim 1 further comprising receiving, via the second wireless connection and from the second electronic device, an indication produced by the second electronic device responsive to the second electronic device receiving user input at the second electronic device to cause the headset to playback the second audio signal.

4. The method of claim 1, wherein the second wireless connection is a bi-directional wireless connection, wherein the method further comprises:
capturing, using a microphone of the headset, a microphone signal that comprises speech data of the user of the headset; and
transmitting, via the bi-directional wireless connection, the microphone signal to the second electronic device such that the user of the headset may perform a communication session through the second electronic device.

5. The method of claim 1, wherein the first wireless connection, the second wireless connection, and the wired connection are contemporaneously active to allow the headset to exchange data with the first electronic device and the second electronic device.

6. The method of claim 1 further comprising:
in response to the wired connection between the headset and the first electronic device being disconnected,
receiving, via the first wireless connection, the first audio signal from the first electronic device;
determining which of the first audio signal or the second audio signal is to be used for the audio playback based on the first wireless connection and the second wireless connection; and
in response to the determining, using either the first audio signal or the second audio signal to drive the at least one speaker.

7. The method of claim 1, wherein the second audio signal and the first audio signal comprise the same audio content, wherein the second audio signal is received via the second wireless connection responsive to the wired connection between the first electronic device has been disconnected.

8. A first electronic device comprising:
at least one processor; and
memory having instructions which when executed by the at least one processor causes the first electronic device to:
establish a first wireless connection with a headset that is worn on a head of a user, while the headset is communicatively coupled with a second electronic device via a wired connection and a second wireless connection, wherein the headset is configured to receive a first audio signal via the wired connection for audio playback through at least one speaker;
determine that the headset is to play back a second audio signal; and
transmit, via the first wireless connection, the second audio signal to the headset, wherein the headset is configured to play back the second audio signal through the at least one speaker instead of the first audio signal, while maintaining the first wireless connection with the second electronic device.

9. The first electronic device of claim 8, wherein the instructions to determine comprises instructions to receive user input to initiate playback of audio content, wherein the second audio signal that comprises the audio content is transmitted responsive to a reception of the user input.

10. The first electronic device of claim 9, wherein the first wireless connection comprises a bi-directional wireless connection, wherein the user input is to initiate an audio communication session between the headset and a remote electronic device, wherein the second audio signal comprises a downlink audio signal of the audio communication session, wherein the memory comprises further instructions to receive, via the bi-directional wireless connection a microphone signal captured by a microphone of the headset for transmission to the remote electronic device.

11. The first electronic device of claim 10, wherein the first audio signal comprises user-desired audio content that is paused during the audio communication session.

12. The first electronic device of claim 8, wherein the instructions to determine that the headset is to play back the second audio signal comprises instructions to receive, via the first wireless connection, a control signal to cause the first electronic device to provide the second audio signal, wherein the control signal is received responsive to the wired connection between the headset and the first electronic device being disconnected.

13. The first electronic device of claim 12, wherein the first audio signal and the second audio signal comprises the same audio content.

14. The first electronic device of claim 8, wherein the first electronic device comprises a portable electronic device and the second electronic device comprises a stationary electronic device.

15. A non-transitory machine-readable medium having instructions which when executed by at least one processor of an electronic device causes the electronic device to:
receive an audio signal, wherein the electronic device is communicatively coupled with 1) a first source device via a first wireless connection and a wired connection through which the audio signal is received, and 2) a second source device via a second wireless connection;
use the audio signal to drive at least one speaker of the electronic device;
receive, via the second wireless connection from the second source device, a subsequent audio signal; and
responsive to receiving the subsequent audio signal and without user intervention, use the subsequent audio signal to drive the at least one speaker instead of the audio signal.

16. The non-transitory machine-readable medium of claim 15 comprising further instructions to receive, via the second wireless connection and from the second source device, an indication produced by the second source device responsive to the second source device receiving user input at the second source device to cause the electronic device to use the subsequent audio signal to drive the at least one speaker instead of using the audio signal.

17. The non-transitory machine-readable medium of claim 15, wherein the second wireless connection is a bi-directional wireless connection, wherein the non-transitory machine-readable medium comprises further instructions to:
capture, using a microphone, a microphone signal that comprises speech data of a user of the electronic device; and
cause the electronic device to transmit, via the bi-directional wireless connection, the microphone signal to the second source device such that the user of the electronic device may perform a communication session through the second source device.

18. The non-transitory machine-readable medium of claim 15, in response to the wired connection between the electronic device and the first source device being disconnected,
receive, via the first wireless connection, the audio signal from the first source device;
determine which of the audio signal or the subsequent audio signal is to be used for audio playback based on the first wireless connection and the second wireless connection; and
in response, use either the audio signal or the subsequent audio signal to drive the at least one speaker.

19. The non-transitory machine-readable medium of claim 15, wherein the subsequent audio signal and the audio signal comprise the same audio content, wherein the subsequent audio signal is received via the second wireless connection responsive to the wired connection with the first source device having been disconnected.

20. The non-transitory machine-readable medium of claim 15, wherein the first source device comprises a stationary electronic device and the second source device comprises a portable electronic device.
